(19) United States
(12) Patent Application Publication
(10) Pub. No.: US 2026/0074361 A1
(43) Pub. Date: Mar. 12, 2026

(54) BATTERY HOUSING ASSEMBLY

(71) Applicant: Ford Global Technologies, LLC, Dearborn, MI (US)

(72) Inventors: Larry Wang, Nanjing (CN); Shiwu Hao, Nanjing (CN); Fei Gao, Hefei (CN)

(73) Assignee: Ford Global Technologies, LLC, Dearborn, MI (US)

(21) Appl. No.: 19/323,171

(22) Filed: Sep. 9, 2025

(30) Foreign Application Priority Data
Sep. 9, 2024 (CN) 202411258927.5

(51) Int. Cl. H01M 50/358; B60L 50/64; H01M 50/242; H01M 50/249; H01M 50/308; H01M 50/691

(52) U.S. Cl. CPC H01M 50/358; H01M 50/242; H01M 50/249; H01M 50/308; H01M 50/691; B60L 50/64; H01M 2220/20

(57) ABSTRACT

A battery housing assembly includes a housing with a through-hole, a ventilation device, and a buffer component. The ventilation device is at least partially located outside the through-hole. The buffer component is located outside the housing and has a protective cavity in fluid communication with the ventilation device, and the ventilation device is located within an orthographic projection of the protective cavity on the housing. The ventilation device may be protected to reduce external impact it may receive, and to permit ventilation when the battery housing assembly is subjected to external forces.

### CROSS-REFERENCE TO RELATED APPLICATION

This application claims priority to and the benefit of Chinese Patent Application No. 202411258927.5, filed on Sep. 9, 2024. The disclosure of the above application is incorporated herein by reference.

### FIELD

The present disclosure relates to vehicles, and more specifically, to a battery housing assembly.

### BACKGROUND

The statements in this section merely provide background information related to the present disclosure and may not constitute prior art.

In electrified vehicles, battery packs are usually included. The battery pack has a housing, on which ventilation devices such as valves are arranged to balance pressure inside and outside the battery pack, and enable rapid gas discharge when desired. The ventilation device typically extends partially beyond the housing of the battery pack to facilitate gas exchange with the external environment.

However, in certain instances the partial exposure of the ventilation devices outside of the housing of the battery pack may leave them unprotected and thus vulnerable.

### SUMMARY

This section provides a general summary of the disclosure and is not a comprehensive disclosure of its full scope or all of its features.

The present disclosure summarizes various aspects of examples and should not be used to limit the claims. Other implementations are contemplated in accordance with the techniques described herein, as will be apparent to those of ordinary skill in the art upon examination of the following drawings and detailed description, and such implementations are intended to be within the scope of this application.

The present disclosure provides a battery housing assembly that can provide protection for the ventilation device to reduce the external force it may receive, and permit its ventilation capability when the battery housing assembly is subjected to external forces.

According to an aspect of the present disclosure, there is provided a battery housing assembly comprising a housing with a through-hole, a ventilation device and a buffer component. The ventilation device is at least partially located outside the through-hole. The buffer component is located outside the housing and has a protective cavity in fluid communication with the ventilation device, and the ventilation device is located within an orthographic projection of the protective cavity on the housing.

According to an example of the present disclosure, an end of the ventilation device that is exposed outside the housing is located within the protective cavity.

According to an example of the present disclosure, a portion of the ventilation device that is located outside the housing is located within the protective cavity.

According to an example of the present disclosure, the battery housing assembly further comprises a connector that cooperates with the ventilation device, wherein the connector is located within the protective cavity.

According to an example of the present disclosure, the buffer component has walls that form the protective cavity, and an end of the ventilation device that is exposed outside the housing is substantially flush with the walls.

According to an example of the present disclosure, the battery housing assembly further comprises a connector that cooperates with the ventilation device, wherein the connector is located between the housing and the buffer component.

According to an example of the present disclosure, the buffer component has walls that form the protective cavity, and an inclined angle is formed between the walls and the orthographic projection.

According to an example of the present disclosure, a collapse box is provided on a side of the buffer component away from the housing.

According to an example of the present disclosure, the buffer component has walls that form the protective cavity, and a notch is provided on the walls.

According to an example of the present disclosure, the buffer component has a first wall that forms the protective cavity and is adjacent to the housing, and a second wall opposite to the first wall, with a gap between the first wall and the second wall.

According to an example of the present disclosure, the buffer component has a second wall that is opposite to the housing, and a gap is formed between the second wall and the housing.

According to an example of the present disclosure, the buffer component comprises a plurality of protective cavities arranged at intervals, and the ratio of the spacing between edges of adjacent protective cavities to the spacing between centres of adjacent protective cavities is within the range of 0.6 to 0.8.

According to an example of the present disclosure, the protective cavity defines a ventilation channel for guiding gas to flow in a predetermined direction.

According to an example of the present disclosure, the buffer component has a second wall that is opposite to the housing, and a vent hole in communication with the ventilation channel is provided on the second wall.

According to an example of the present disclosure, the buffer component has walls that form the protective cavity, and a liquid discharge hole is provided on the walls.

According to another aspect of the present disclosure, there is provided a battery housing assembly comprising a housing with a through-hole, a ventilation device, a buffer component and a connector. The ventilation device is at least partially located outside the through-hole. The buffer component is located outside the housing and has a protective cavity. The connector is disposed on the buffer component and located within the protective cavity. The connector is connected to the ventilation device to fix the buffer component to the housing.

According to an example of the present disclosure, the buffer component has walls that form the protective cavity, and an insertion slot that allows the connector to be inserted into the protective cavity is provided on the walls.

According to an example of the present disclosure, the ventilation device has an extending portion that protrudes out of the through-hole, the extending portion is provided with external threads; and the connector has a connecting ring, the connecting ring is provided with internal threads that cooperate with the external threads.

According to an example of the present disclosure, the buffer component has a first wall that is in close contact with the housing, the first wall is provided with a positioning portion, and the connector is provided with a matching slot that cooperates with the positioning portion.

According to an example of the present disclosure, the matching slot extends along a height direction of the housing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 is a schematic diagram showing a side view of a vehicle according to an example of the present disclosure;

FIG. 2 is a schematic diagram showing a perspective exploded view of a battery pack according to an example of the present disclosure;

FIG. 3 is a schematic diagram showing a detail perspective view of a battery housing assembly according to a first example of the present disclosure;

FIG. 4 is a schematic diagram showing an orthographic projection of a protective cavity of the battery housing assembly in FIG. 3 on a housing;

FIG. 5 is a cross-sectional view showing the battery housing assembly in FIG. 3;

FIG. 6 is a schematic diagram showing a detail perspective view of the cooperation between a connector and a buffer component of the battery housing assembly in FIG. 3;

FIG. 7 is a schematic diagram showing a detail perspective view of a partial structure of the buffer component of the battery housing assembly in FIG. 3;

FIG. 8 is another schematic diagram showing a perspective view of a partial structure of the buffer component of the battery housing assembly in FIG. 3;

FIG. 9 is a schematic diagram showing a perspective exploded view of an overall structure of the buffer component of the battery housing assembly in FIG. 3;

FIG. 10 is a cross-sectional view showing a battery housing assembly according to a second example of the present disclosure;

FIG. 11 is a cross-sectional view showing a battery housing assembly according to a third example of the present disclosure;

FIG. 12 is a cross-sectional view showing a battery housing assembly according to a fourth example of the present disclosure; and

FIG. 13 is a cross-sectional view showing a battery housing assembly according to a fifth example of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Examples of the present disclosure are described below. However, it is to be understood that the disclosed examples are merely examples and other examples may take various and alternative forms. The figures are not necessarily to scale; some features may be exaggerated or reduced to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce examples not expressly shown or described. The combinations of features shown herein provide representative examples for typical applications. However, various combinations and modifications of the features consistent with the teachings of the present disclosure may be desired for certain particular applications or implementations.

In this application document, when an element or portion is referred to as being “on . . . ”, “joined to”, “connected to”, or “coupled to” another element or portion, the element or portion may be directly on, joined, connected, or coupled to the another element or portion, or there may be intervening elements or portions. In contrast, when an element is referred to as being “directly on . . . ”, “directly joined to”, “directly connected to”, or “directly coupled to” another element or portion, there may be no intervening element or portion. Other terms used to describe the relationship between elements should be interpreted in a similar manner.

As mentioned, the ventilation devices may be typically partially exposed outside the housing of the battery pack, and when the vehicle is subjected to external forces, the ventilation devices that protrude out of the housing may be prone to issues due to their ability to directly bear large forces, which may result in the inability of the battery pack to ventilate properly. The following disclosure provides a battery housing assembly in one or more forms.

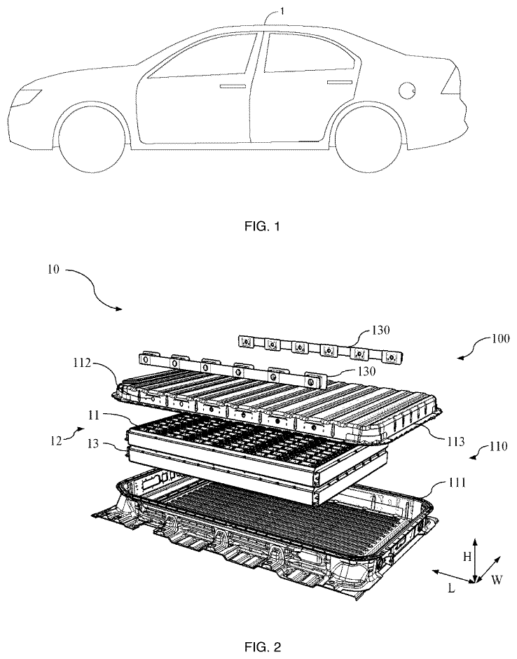

FIG. 1 is a schematic diagram showing a vehicle 1 according to an example of the present disclosure. The vehicle 1 may refer to any means of transportation that includes a battery pack. For example, it may include, but are not limited to, fossil fuel vehicles, electric vehicles (such as plug-in hybrid electric vehicles (PHEVs), full hybrid electric vehicles (FHEVs), mild hybrid electric vehicles (MHEVs), or battery electric vehicles (BEVs)), and may even include ships, aircraft, and the like. The vehicle 1 may include components related to mobility, such as an engine, an electric motor, a transmission, a suspension, a drive shaft, and/or wheels. The vehicle 1 may be non-autonomous, semi-autonomous (e.g., some conventional movement functions are autonomously controlled by the vehicle), or autonomous (e.g., movement functions are autonomously controlled by the vehicle without direct user input).

FIG. 2 is a schematic diagram showing a battery pack 10 according to an example of the present disclosure. Referring to FIG. 2, the battery pack 10 includes a battery housing assembly 100 and a battery module 12 accommodated in the battery housing assembly 100. The battery housing assembly 100 may include a housing 110 and various possible functional attachments. These attachments are disposed on the housing 110 and are used to provide functions such as ventilation, heat dissipation, thermal insulation, strength enhancement, shock absorption, and auxiliary installation. The attachments may include a ventilation device 120 and a buffer component 130, which will be described in detail below. The housing 110 may include a tray 111 for supporting the battery module 12 and a top cover 113 for covering the battery module 12. The tray 111 and the top cover 113 together define an accommodation cavity for housing the battery module 12. The tray 111 may be a box-shaped structure with a top opening, including a tray bottom plate and one or more tray side plates extending upward from a peripheral side of the tray bottom plate. The top cover 113 covers the top opening of the tray 111. The top cover 113 may be a box-shaped structure with a bottom opening, including a top cover top plate and one or more top cover side plates extending downward from a peripheral side of the top cover top plate. The top opening of the tray 111 and the bottom opening of the top cover 113 are aligned with each other, thus forming the accommodation cavity by the enclosure of the housing 110. Flanges may be provided at the top opening of the tray 111 and the bottom opening of the top cover 113, and matching connection structures are disposed on the flanges to realize the connection between the tray 111 and the top cover 113. The housing 110 defines a length direction L, a width direction W, and a height direction H. The battery module 12 may include a plurality of battery cells 11 arranged in an array. The plurality of battery cells 11 may be arranged in multiple rows, wherein the plurality of battery cells 11 in each row are arranged along the width direction W of the housing 110, and the multiple rows of battery cells are arranged along the length direction L of the housing 110. The battery module 12 may further include a frame 13 for enclosing and restricting the battery cell array. The frame 13 may include a plurality of side beams connected in sequence. The battery module 12 may also include a battery management unit for controlling the charging and discharging of the plurality of battery cells 11.

The battery pack 10 may have a variety of application scenarios. In the example of the present disclosure, the battery pack 10 is applied in the vehicle. The length direction L, width direction W, and height direction H of the housing 110 may correspond to a longitudinal direction (front-rear direction), lateral direction, and height direction of the vehicle, respectively.

Those skilled in the art should understand that although in the above examples the battery housing assembly 100 is shown as being used to accommodate the battery module 12, and serve as a housing assembly constituting a complex battery pack 10, in alternative examples, the battery housing assembly 100 may also be used to accommodate battery cells, and merely serve as a housing assembly constituting a simple battery cell.

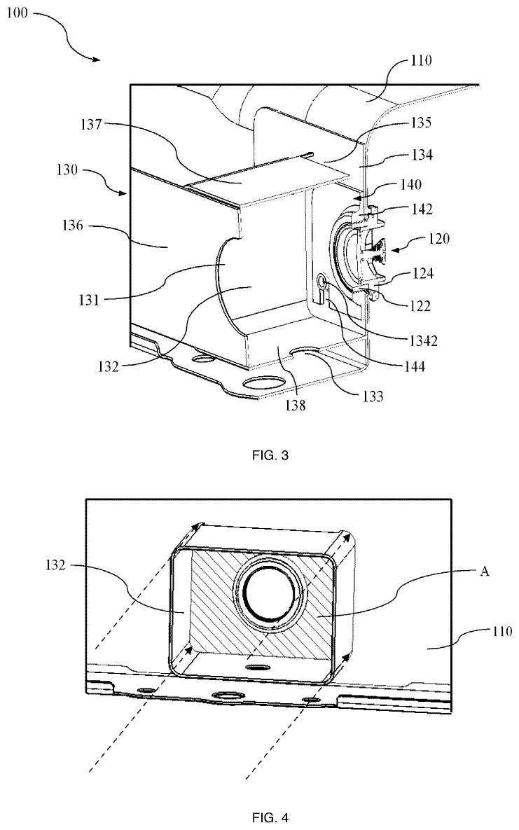

Referring to FIGS. 2 and 3, the battery housing assembly 100 includes the housing 110 with a through-hole 112, the ventilation device 120, and the buffer component 130. The ventilation device 120 is at least partially located outside the through-hole 112. The buffer component 130 is located outside the housing 110 and has a protective cavity 132 in fluid communication with the ventilation device 120, and the ventilation device 120 is located within an orthographic projection A of the protective cavity 132 on the housing 110.

As shown in FIG. 4, the orthographic projection A of the protective cavity 132 on the housing 110 can represent the area formed on a projection plane defined by the housing 110 by projecting each point contained in the protective cavity 132 onto the projection plane defined by the housing 110 through a set of parallel projection lines perpendicular to the projection plane defined by the housing 110 (some projection lines are shown by dashed arrows in FIG. 4).

In an example of the present disclosure, the ventilation device 120 is located within the orthographic projection A of the protective cavity 132 on the housing 110, such that the protective cavity 132 at least partially covers the outer side of the ventilation device 120. When the battery housing assembly 100 is subjected to external forces, the walls defining the protective cavity 132 first undergo deformation and absorb energy, reducing the external impact on the inner part of the ventilation device 120 and protecting the ventilation device 120, thereby ensuring the ventilation of the battery. Meanwhile, the buffer component 130 including the protective cavity 132 can also improve the rigidity of the housing 110, reduce the external impact on the housing 110, and reduce the extrusion of the housing 110, thereby protecting the battery inside the housing 110.

The ventilation device 120 and the buffer component 130 can be arranged at any suitable position of the housing 110, for example, can be arranged on the tray 111 and/or the top cover 113, specifically, can be arranged on the tray bottom plate, tray side plates, top cover top plate and/or top cover side plates, as long as the corresponding positions have the need for ventilation and protection. In a specific example, the ventilation device 120 and the buffer component 130 are arranged on the two top cover side plates of the top cover 113 of the housing 110 extending along the length direction L.

The ventilation device 120 can be any device suitable for realizing gas exchange between the interior and exterior of the housing 110. For example, the ventilation device 120 can be a valve, a blower, a fan, an air duct, etc. The ventilation device 120 can be configured to: discharge the gas inside the housing 110 to the external environment when the gas pressure inside the housing 110 is greater than the gas pressure of the external environment and the pressure difference is greater than a corresponding threshold; permit the gas from the external environment to flow into the housing 110 when the gas pressure of the external environment is greater than the gas pressure inside the housing 110 and the pressure difference is greater than the corresponding threshold; and inhibit the gas exchange between the interior and exterior of the housing 110 when the pressure difference between the gas pressure inside the housing 110 and the gas pressure of the external environment is within the corresponding threshold range. The pressure balance between the interior and exterior of the housing 110 is thus maintained.

Referring to FIG. 3, the ventilation device 12 extends through the through-hole 112 of the housing 110, thereby enabling communication between the interior and exterior of the housing 110. The term “extend through” may mean that the ventilation device 12 extends from the interior of the housing 110 through the through-hole 112 to the exterior of the housing 110, and at this time, a portion of the ventilation device 12 is located outside the through-hole 112. Those skilled in the art should understand that the ventilation device 12 can also be completely arranged outside the housing 110 and a ventilation port of the ventilation device 12 is aligned with the through-hole 112 , and at this time, the ventilation device completely located outside the through-hole 112 can also realize the communication between the interior and exterior of the housing 110.

The protective cavity 132 is a space defined by walls. The buffer component 130 has walls for defining the protective cavity 132. In addition to the space located inside the walls, when an opening is formed on the walls, the protective cavity 132 can also include the space defined by the wall thickness at the opening. The shape of the protective cavity 132 can be a cuboid, enclosed by six walls from various directions. Those skilled in the art should understand that the protective cavity 132 can also be constructed into any other suitable shape. The protective cavity 132 can have a substantially regular shape, such as a cuboid, cube, parallelepiped, cylinder, or other regular polyhedrons. The protective cavity 132 can also be designed into an irregular shape according to predetermined considerations, such as protruding or extending from a main body in a specific direction. The three-dimensional structure of the protective cavity 132 enables the walls forming the protective cavity 132 to fully deform when subjected to external forces, thereby absorbing impact energy as much as possible and playing a good buffering role.

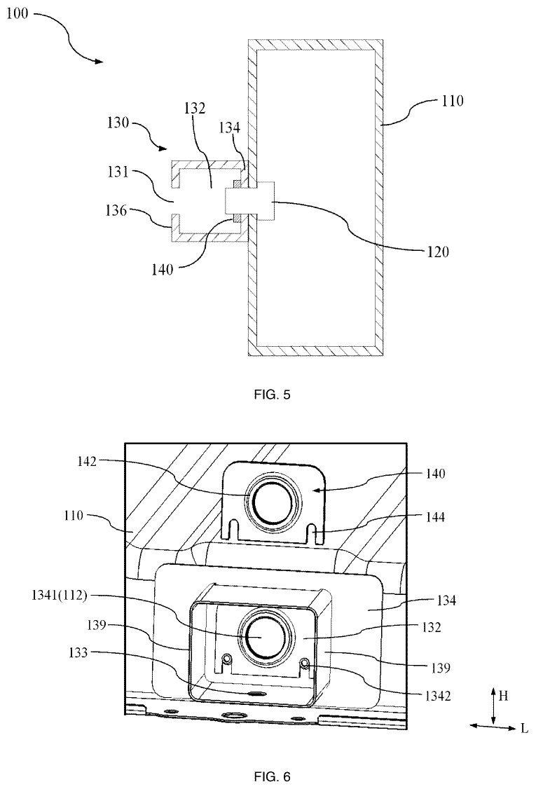

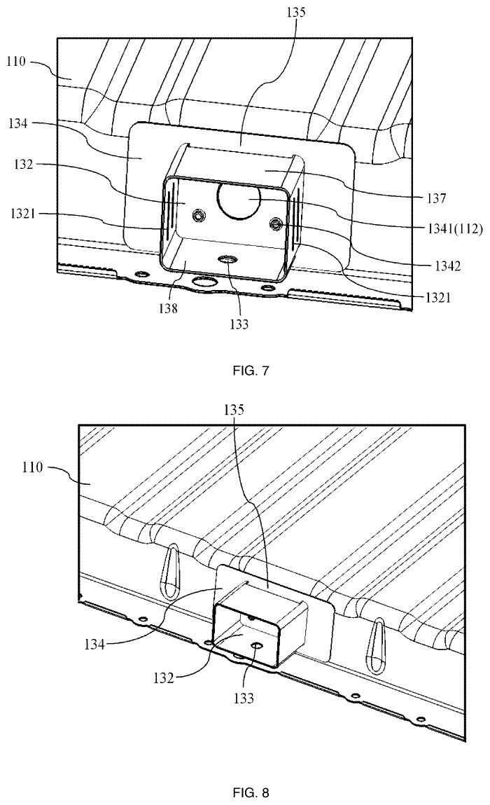

FIGS. 3 to 9 are schematic diagrams showing a battery housing assembly according to a first example of the present disclosure. Referring to FIGS. 3 and 5, the portion of the ventilation device 120 located outside the housing 110 is located within the protective cavity 132. Specifically, an end of the ventilation device 120 exposed outside the housing 110 and other portions located outside the housing 110 are all located within the protective cavity 132. At this time, the gas discharged by the ventilation device 120 can directly enter the protective cavity 132, and the ventilation device 120 is in fluid communication with the protective cavity 132. Meanwhile, the protective cavity 132 surrounds the portion of the ventilation device 120 that is located outside the housing 110 to protect it. That is, a portion of the ventilation device 120 is located inside the housing 110, and the portion of the ventilation device 120 located outside the housing 110 is located within the protective cavity 132, so that the ventilation device 120 is not exposed and can be protected by the housing 110 and the protective cavity 132. Referring to FIGS. 6 and 7, the buffer component 130 has an opening 1341 in communication with the protective cavity 132, so that the ventilation device 120 extends into the protective cavity 132 through the opening 1341.

Referring to FIG. 3, the walls forming the protective cavity 132 include a first wall 134 close to the housing 110 and a second wall 136 opposite to the first wall 134, with a gap between the first wall 134 and the second wall 136. The distance between the first wall 134 and the second wall 136 defines a distance of the buffer component 130, and the distance between the first wall 134 and the second wall 136 can be set according to actual needs to achieve the desired buffering effect. The walls forming the protective cavity 132 also include other walls connected between the first wall 134 and the second wall 136 to play a supporting and energy-absorbing role, such as a top wall 137, a bottom wall 138, and two opposite side walls 139.

Referring to FIG. 3, the ventilation device 120 is arranged on the side of the buffer component 130 close to the housing 110, so as to be as far as possible from the side of the buffer component 130 that first receives external impact. This can extend the path that the external force needs to travel to reach the ventilation device 120, providing that the buffer component 130 fully collapses to absorb energy as much as possible before the external force acts on the ventilation device 120, and thereby better protecting the ventilation device 120.

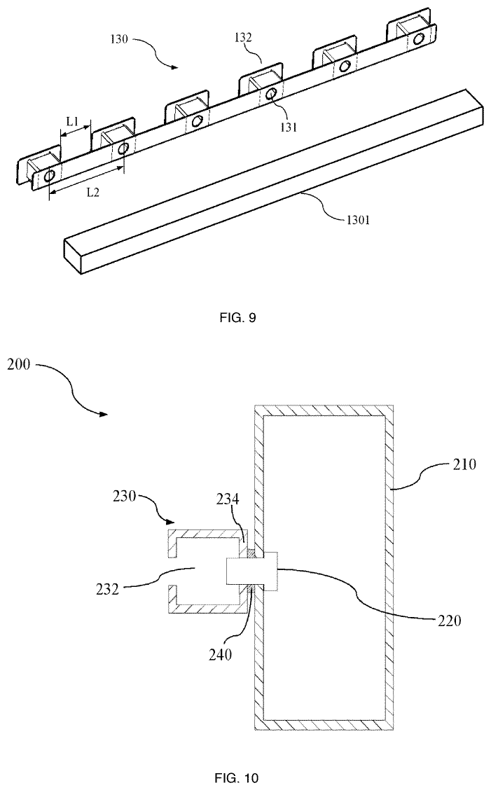

Structures capable of improving the collapse capability can be provided on the buffer component 130. Referring to FIG. 9, in one example, a collapse box 1301 can be provided on a side of the buffer component 130 away from the housing 110. The collapse box 1301 can have, for example, a honeycomb structure. Collapse inducing grooves can be provided on the collapse box 1301. In one example, the buffer component 130 includes a plurality of protective cavities 132 arranged at intervals, and multiple collapse boxes 1301 can be provided between adjacent protective cavities 132. Referring to FIG. 7, in one example, a notch 1321 can be provided on the walls forming the protective cavity 132, which is beneficial for causing the wall to collapse and absorb energy. The notch 1321 can be provided on any suitable walls that form the protective cavity 132, and the notch 1321 can extend in a vertical, horizontal, or other suitable directions, and can be set in a straight, curved, or other suitable shape. In one example, the wall forming the protective cavity 132 can be designed to have an S-shaped or corrugated structure to guide collapse.

The protective cavity 132 defines a ventilation channel for guiding gas to flow in a predetermined direction. The gas discharged by the ventilation device 120 into the protective cavity 132 can be guided through the ventilation channel in the predetermined direction to a position that does not affect the components near the housing 110. The gas guiding direction of the ventilation channel can be predetermined according to actual conditions (e.g., the installation and arrangement of components near the housing 110). The ventilation channel may extend along a straight line and/or a curved line to guide the gas to flow along a desired path.

Referring to FIG. 3, a vent hole 131 in communication with the ventilation channel and the external environment is provided on the second wall 136 that is opposite to the housing 110, through which gas is discharged to the external environment. Since the ventilation device 120 is disposed on the housing 110 and the vent hole 131 is provided on the second wall 136 opposite to the housing 110, the gas discharged by the ventilation device 120 can flow directly to the vent hole 131, ensuring smooth gas discharge and improving exhaust efficiency. Those skilled in the art should understand that the vent hole 131 can also be provided on any other suitable wall of the buffer component 130 to guide the gas to a desired position for discharge. The wall on which the vent hole 131 is provided can be predetermined according to actual needs.

Referring to FIGS. 3, 6 to 8, a liquid discharge hole 133 is provided on the walls forming the protective cavity 132. In a specific example, the liquid discharge hole 133 is provided on the bottom wall 138 forming the protective cavity 132. In some cases, liquid (e.g., liquid condensed from the high-temperature gas discharged by the ventilation device 120 into the protective cavity 132) may be present in the protective cavity 132. The liquid discharge hole 133 can timely discharge the liquid inside the protective cavity 132 to the external environment, inhibiting the accumulation of the liquid in the protective cavity 132 and thus reducing corrosion of the buffer component 130.

Referring to FIGS. 3, 5, and 6, the battery housing assembly 100 further includes a connector 140. The connector 140 is disposed on the buffer component 130 and cooperates with the ventilation device 120 to fix the buffer component 130 onto the housing 110. The connector 140 is used to facilitate the installation of the buffer component 130. Compared with fixing the buffer component 130 to the housing 110 through the cooperation between the connector 140 and the additional mating component, the present disclosure achieves the fixation of the buffer component 130 to the housing 110 by connecting the connector 140 to the ventilation device 120. When installing the buffer component onto the battery housing, the existing structure of the ventilation device 120 on the battery housing can be utilized, additional mating components may be omitted, and additional holes drilled in the housing 110 may be omitted. This is beneficial for the installation of the buffer component 130, which can enhance production efficiency.

The connector 140 is located inside the protective cavity 132 so as to be connected with the ventilation device 120. Meanwhile, the protective cavity 132 can protect the connector 140, thereby enhancing the connection reliability between the connector 140 and the ventilation device 120. Referring to FIGS. 3 and 7, an insertion slot 135 that allows the connector 140 to be inserted into the protective cavity 132 is provided on the walls forming the protective cavity 132. In a specific example, the insertion slot 135 is provided on the top wall 137 forming the protective cavity 132. During installation, the connector 140 can be inserted into the protective cavity 132 from top to bottom through the insertion slot 135.

Referring to FIG. 3, the ventilation device 120 has an extending portion 122 that protrudes out of the through-hole 112, and the extending portion 122 is provided with external threads. The connector 140 has a connecting ring 142, and the connecting ring 142 is provided with internal threads that cooperate with the external threads. The ventilation device 120 includes an abutting portion 124 located inside the housing 110. The abutting portion 124 protrudes relative to the extending portion 122, thereby being blocked from the through-hole 112 and remaining inside the housing 110. The first wall 134 forming the protective cavity 132 is arranged in close contact with the housing 110, and the connector 140 is detachably disposed on the surface of the first wall 134 facing away from the housing 110. When the ventilation device 120 is screwed into the connecting ring 142 of the connector 140 which has internal threads, the abutting portion 124 of the ventilation device 120 and the connector 140 jointly clamp the first wall 134 and the housing 110. Under the clamping action, the connector 140, the ventilation device 120, the first wall 134 of the buffer component 130, and the housing 110 are tightly fixed together, thus realizing the simultaneous fixation of the ventilation device 120 and the buffer component 130 to the housing 110. In this way, the connector 140 and the ventilation device 120 serve as mating parts for each other, eliminating the need to provide separate connecting mating parts for the connector 140 and the ventilation device 120 respectively, which reduces parts. Moreover, compared with fixing the connector 140 and the ventilation device 120 to the housing 110 separately, the present disclosure achieves their simultaneous fixation by interconnecting them, simplifying the assembly process and improving assembly efficiency. In the form of the present disclosure, the connector 140 functions like a nut, and the ventilation device 120 functions like a bolt (wherein the abutting portion 124 corresponds to the head of the bolt, and the extending portion 122 corresponds to the shank of the bolt). The two serve as mating parts for each other, additional bolts for the connector 140 may be omitted, and additional nuts for the ventilation device 120 may be omitted.

As described above, the connector 140, the ventilation device 120, the first wall 134 of the buffer component 130, and the housing 110 are fixed together by clamping. This means the connector 140 does not need to be connected (e.g., welded) to the buffer component 130, further reducing welding processes and welding costs. When the connector 140 is not connected to the buffer component 130, the connector 140 can be simply positioned on the buffer component 130 to facilitate its connection with the ventilation device 120. Referring to FIG. 6, the first wall 134 is provided with a positioning portion 1342, and the connector 140 is provided with a matching slot 144 that cooperates with the positioning portion 1342. The positioning of the connector 140 is achieved through the cooperation between the positioning portion 1342 and the matching slot 144. This not only aligns the connector 140 with the ventilation device 120 for easy connection, but also inhibits the connector 140 from shifting and/or rotating during the connection process with the ventilation device 120 (which would otherwise affect the connection). In this example, the insertion slot 135 may be located at the junction between the wall (on which it is disposed) and the first wall 134, allowing the connector 140 to be inserted against the first wall 134. This provides that the matching slot 144 on the connector 140 can smoothly mate with the positioning portion 1342 on the first wall 134. In one example, the positioning portion 1342 may be a protrusion on the first wall 134 (e.g., a positioning pin). A protruding stop portion may be provided at the end of the positioning portion 1342 to inhibit the connector 140 from slipping off.

Referring to FIG. 6, the matching slot 144 extends along the height direction H of the housing 110, thereby enabling the position of the connector 140 in the height direction H to be adjustable to accommodate assembly tolerances, ensuring that the connector 140 can be adjusted to align with the position of the ventilation device 120. Alternatively, in other examples, the matching slot 144 is T-shaped and includes a first segment extending along the height direction H of the housing 110 and a second segment extending along a direction perpendicular to the height direction H (e.g., the length direction L). This allows the position of the connector 140 to be adjusted in both the height direction H and the length direction L, better accommodating assembly tolerances.

A method for installing the buffer component 130 onto the housing 110 may include the following. First, as shown in FIG. 7, the position of the buffer component 130 is adjusted to a predetermined installation position. At this position, the first wall 134 is in close contact with the housing 110, and the opening 1341 of the buffer component 130 is aligned with the through-hole 112 on the housing 110. Next, as shown in FIG. 6, the connector 140 is inserted into the protective cavity 132 through the insertion slot 135, and the matching slot 144 on the connector 140 is engaged with the positioning portion 1342 on the first wall 134. Then, the position of the connector 140 is fine-tuned along the height direction H of the housing 110 to align the connecting ring 142 of the connector 140 with the through-hole 112 on the housing 110, completing the positioning of the connector 140 on the first wall 134. Subsequently, referring to FIG. 3, the ventilation device 120 with external threads is screwed from the inside of the housing 110 into the connecting ring 142 with internal threads. When tightened, the abutting portion 124 of the ventilation device 120 and the connector 140 jointly clamp the first wall 134 of the buffer component 130 and the housing 110, realizing the simultaneous fixation of the buffer component 130 and the ventilation device 120 to the housing 110. The installation is thus completed.

Those skilled in the art should understand that, in alternative examples, the connector 140 may also be fixedly connected to the buffer component 130 by means such as welding, screwing, riveting, etc. In alternative examples, one of the extending portions 122 and the connecting ring 142 is provided with a protrusion, and the other is provided with a slot that mates with the protrusion. Through the engagement of the protrusion and the slot, the connector 140 and the ventilation device 120 jointly clamp the housing 110 and the first wall 134.

Referring to FIG. 9, the buffer component 130 includes a plurality of protective cavities 132 arranged at intervals. There is a spacing L1 between edges of adjacent protective cavities 132, and a spacing L2 between centers of adjacent protective cavities 132. The ratio of L1 to L2 is within the range of 0.6 to 0.8, for example, within the range of 0.6 to 0.7. Those skilled in the art should understand that a greater number of protective cavities 132 and a denser arrangement result in higher strength of the buffer component 130, but this also leads to excessive material usage and increased weight. Conversely, a smaller number of protective cavities 132 and a sparser arrangement reduces materials and weight, but result in lower strength of the buffer component 130. By designing an appropriate ratio of L1 to L2, the present disclosure balances the strength of the buffer component 130 with material usage and weight, achieving a desired outcome—i.e., increased strength with appropriate material consumption and weight.

Referring to FIGS. 2, 3, and 9, the housing 110 is provided with a plurality of through-holes 112 arranged along the length direction L. The battery housing assembly 100 includes a plurality of ventilation devices 120 arranged along the length direction L, and the buffer component 130 includes a plurality of protective cavities 132 arranged along the length direction L. The plurality of protective cavities 132 protect and communicate with the plurality of ventilation devices 120 in a one-to-one correspondence. The battery housing assembly 100 includes a plurality of connectors 140, which connect to the plurality of ventilation devices 120 in a one-to-one correspondence to fix the entire buffer component 130 to the housing 110. The second walls 136 of the plurality of protective cavities 132 may be connected to each other or extended into an elongated plate extending along the length direction L, ensuring the integrity of the buffer component 130, facilitating installation, and promoting mutual force transmission and balance. In general, the buffer component 130 may include a plurality of plates (forming the plurality of first walls 134) arranged at intervals along the length direction L, an elongated plate (providing the plurality of second walls 136), and a plurality of box-shaped brackets connected between the plurality of plates and the elongated plate (providing the top wall 137, bottom wall 138, and two additional side walls 139 that form the protective cavity 132). The housing 110 may be provided with a positioning portion for positioning the buffer component 130 in the length direction L and/or height direction H, so as to position the buffer component 130 to the predetermined installation position.

Referring to FIG. 10, which shows a cross-sectional view of a battery housing assembly 200 according to a second example of the present disclosure, the battery housing assembly 200 is substantially similar to the battery housing assembly 100. For brevity, only the differences between the battery housing assembly 200 and the battery housing assembly 100 are described in detail. In the battery housing assembly 200, an end of a ventilation device 220 exposed outside a housing 210 is located within a protective cavity 232, while a portion of the ventilation device 220 located outside the housing 210 is located between the housing 210 and the protective cavity 232. A connector 240, which cooperates with the ventilation device 220, is located between the housing 210 and a buffer component 230. The connector 240 is fixedly connected to the buffer component 230 by means such as welding, screwing, riveting, etc. A method for installing the buffer component 230 onto the housing 210 includes the following. First, the connector 240 is fixedly connected to the outer side of the first wall 234 of the buffer component 230. Next, the position of the buffer component 230 is adjusted to a predetermined installation position. At this position, the connector 240 is in close contact with the housing 210, and an opening on the buffer component 230 is aligned with a through-hole on the housing 210. Then, the ventilation device 220 with external threads is screwed from the inside of the housing 210 into the connecting ring with internal threads of the connector 240. When tightened, an abutting portion of the ventilation device 220 and the connector 240 jointly clamp the housing 210, realizing the simultaneous fixation of the buffer component 230 and the ventilation device 220 to the housing 210. The installation is thus completed.

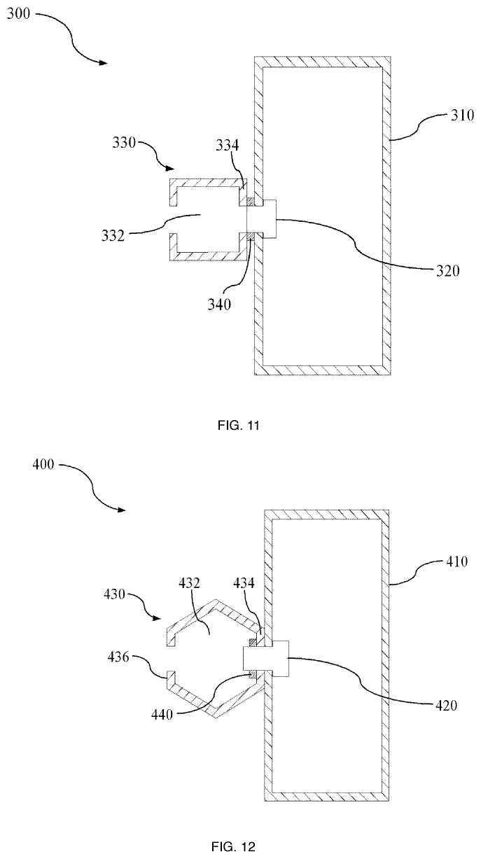

Referring to FIG. 11, which shows a cross-sectional view of a battery housing assembly 300 according to a third example of the present disclosure, the battery housing assembly 300 is substantially similar to the battery housing assembly 100. For brevity, only the differences between the battery housing assembly 300 and the battery housing assembly 100 are described in detail. In the battery housing assembly 300, a portion of the ventilation device 320 located outside a housing 310 is aligned with and adjacent to an opening on the wall forming a protective cavity 332, but does not extend into the protective cavity 332. An end of the ventilation device 320 exposed outside the housing 310 is substantially flush with the walls forming the protective cavity 332. In this example, the ventilation device 320 can be in fluid communication with the protective cavity 332 through an opening on the walls, while the protective cavity 332 covers the outer side of the ventilation device 320 and can collapse first to reduce external impact on the ventilation device 320. A connector 340, which cooperates with the ventilation device 320, is located between the housing 310 and a buffer component 330. The connector 340 is fixedly connected to the buffer component 330 by means such as welding, screwing, riveting, etc. A method for installing the buffer component 330 onto the housing 310 includes the following. First, the connector 340 is fixedly connected to the outer side of the first wall 334 of the buffer component 330. Next, the position of the buffer component 330 is adjusted to a predetermined installation position. At this position, the connector 340 is in close contact with the housing 310, and the opening on the buffer component 330 is aligned with the through-hole on the housing 310. Then, the ventilation device 320 with external threads is screwed from the inside of the housing 310 into the connecting ring with internal threads of the connector 340. When tightened, an abutting portion of the ventilation device 320 and the connector 340 jointly clamp the housing 310, realizing the simultaneous fixation of the buffer component 330 and the ventilation device 320 to the housing 310. The installation is thus completed.

Refer to FIG. 12, which shows a cross-sectional view of a battery housing assembly 400 according to a fourth example of the present disclosure. The battery housing assembly 400 is substantially similar to the battery housing assembly 100. For the sake of brevity, only the differences between the battery housing assembly 400 and the battery housing assembly 100 will be described in detail. In the battery housing assembly 400, walls of a buffer component 430 that form the protective cavity 432 form an inclined angle with an orthographic projection of a protective cavity 432 on a housing 410; the wall is thus prone to collapse and deform under external force to absorb energy. Meanwhile, the strength can be enhanced by increasing the thickness of the buffer component 430. FIG. 12 shows that the protective cavity 432 is in the shape of a regular hexagonal prism. A first wall 434 of the protective cavity 432 that is in close contact with the housing 410, and a second wall 436 opposite to the first wall 434, are both parallel to the orthographic projection, while the other four walls all form an inclined angle with the orthographic projection. Those skilled in the art should understand that the shape of the protective cavity 432 is not limited to the regular hexagonal prism, but can also be other shapes suitable for providing walls inclined relative to the orthographic projection.

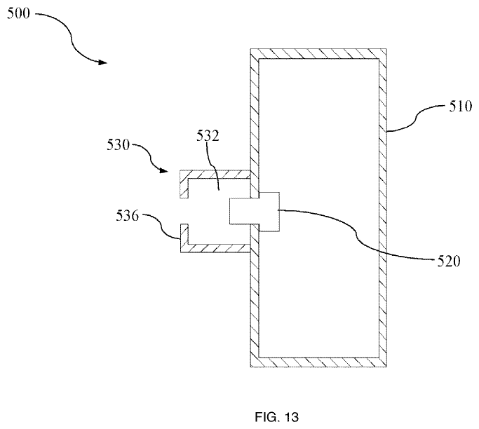

Refer to FIG. 13, which shows a cross-sectional view of a battery housing assembly 500 according to a fifth example of the present disclosure. The battery housing assembly 500 is substantially similar to the battery housing assembly 100. For the sake of brevity, only the differences between the battery housing assembly 500 and the battery housing assembly 100 will be described in detail. In the battery housing assembly 500, a side of a protective cavity 532 close to a housing 510 is open. A buffer component 530 has a second wall 536 that is opposite to the housing 510, and there is a gap between the second wall 536 and the housing 510. The buffer component 530 and a ventilation device 520 are each fixedly connected to the housing 510 through corresponding connection methods, and the connection methods are not limited to welding, screwing, riveting, clamping, and other methods.

It should be understood that, on the premise of technical feasibility, the technical features listed for different examples above can be combined with each other to form additional examples within the scope of the present disclosure.

In this application, the use of the disjunctive is intended to include the conjunctive. The use of definite or indefinite articles is not intended to indicate cardinality. In particular, references to “the” object or “a” and “an” object are intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes”, “including”, and “include” are inclusive and have the same scope as “comprises,”“comprising,”and “comprise”respectively.

The above-mentioned examples are possible examples of implementations of the present disclosure and are given merely to enable those skilled in the art to clearly understand the principles of the disclosure. It should be understood by those skilled in the art that the above discussion to any example is merely illustrative, and is not intended to imply that the disclosed scope of the examples of the present disclosure (including claims) is limited to these examples; and under the overall concept of the disclosure, the technical features in the above examples or different examples can be combined with each other to produce many other changes in different aspects of examples of the disclosure that is not provided in detailed description for the sake of brevity. Therefore, any omission, modification, equivalent replacement, improvement, etc. made within the spirit and principle of the example of the disclosure shall be included in the scope of protection claimed by the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery housing assembly, comprising:
a housing with a through-hole;
a ventilation device at least partially located outside the through-hole; and
a buffer component located outside the housing, the buffer component having a protective cavity in fluid communication with the ventilation device, and the ventilation device is located within an orthographic projection of the protective cavity on the housing.

2. The battery housing assembly according to claim 1, wherein an end of the ventilation device that is exposed outside the housing is located within the protective cavity.

3. The battery housing assembly according to claim 2, wherein a portion of the ventilation device that is located outside the housing is located within the protective cavity.

4. The battery housing assembly according to claim 2, further comprising a connector that cooperates with the ventilation device, and the connector is located within the protective cavity.

5. The battery housing assembly according to claim 1, wherein the buffer component has walls that form the protective cavity, and an end of the ventilation device that is exposed outside the housing is substantially flush with the walls.

6. The battery housing assembly according to claim 5, further comprising a connector that cooperates with the ventilation device, and the connector is located between the housing and the buffer component.

7. The battery housing assembly according to claim 1, wherein the buffer component has walls that form the protective cavity, and an inclined angle is formed between the walls and the orthographic projection.

8. The battery housing assembly according to claim 1, wherein a collapse box is provided on a side of the buffer component away from the housing.

9. The battery housing assembly according to claim 1, wherein the buffer component has walls that form the protective cavity, and a notch is provided on the walls.

10. The battery housing assembly according to claim 1, wherein the buffer component has a first wall that forms the protective cavity and is adjacent to the housing, and a second wall opposite to the first wall, with a gap between the first wall and the second wall.

11. The battery housing assembly according to claim 1, wherein the buffer component has a second wall that is opposite to the housing, and a gap is formed between the second wall and the housing.

12. The battery housing assembly according to claim 1, wherein the buffer component comprises a plurality of protective cavities arranged at intervals, and a ratio of a spacing between edges of adjacent protective cavities to the spacing between centers of adjacent protective cavities is within a range of 0.6 to 0.8.

13. The battery housing assembly according to claim 1, wherein the protective cavity defines a ventilation channel for guiding gas to flow in a predetermined direction.

14. The battery housing assembly according to claim 13, wherein the buffer component has a second wall that is opposite to the housing, and a vent hole in communication with the ventilation channel is provided on the second wall.

15. The battery housing assembly according to claim 1, wherein the buffer component has walls that form the protective cavity, and a liquid discharge hole is provided on the walls.

16. A battery housing assembly, comprising:
a housing with a through-hole;
a ventilation device at least partially located outside the through-hole;
a buffer component located outside the housing and having a protective cavity; and
a connector disposed on the buffer component and located within the protective cavity, and the connector is connected to the ventilation device to fix the buffer component to the housing.

17. The battery housing assembly according to claim 16, wherein the buffer component has walls that form the protective cavity, and an insertion slot that allows the connector to be inserted into the protective cavity is provided on the walls.

18. The battery housing assembly according to claim 16, wherein the ventilation device has an extending portion that protrudes out of the through-hole, the extending portion is provided with external threads and the connector has a connecting ring that is provided with internal threads that cooperate with the external threads.

19. The battery housing assembly according to claim 16, wherein the buffer component has a first wall that is in close contact with the housing, the first wall is provided with a positioning portion, and the connector is provided with a matching slot that cooperates with the positioning portion.

20. The battery housing assembly according to claim 19, wherein the matching slot extends along a height direction of the housing.
